(19) United States
(12) Patent Application Publication
(10) Pub. No.: US 2005/0149923 A1
(43) Pub. Date: Jul. 7, 2005

(54) System update protocol

(76) Inventor: Sheng Lee, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 11/034,618

(22) Filed: Jan. 13, 2005

Related U.S. Application Data
(63) Continuation-in-part of application No. 10/156,303, filed on May 28, 2002.

(51) Int. Cl. G06F 9/44

(52) U.S. Cl. 717/172

(57) ABSTRACT

A system update protocol. A software update is packed into a packed file, which packed file includes a unique signature. The packed file is uploaded from a trusted client computer to the network printer. The integrity of the packed file is automatically checked on the network printer by performing a checksum and signature comparison to ensure the packed file is transmitted correctly. The packed file is resent when the packed file is determined to be corrupt. The packed file is unpacked into a predetermined directory structure of unpacked files. The client computer then signals the network printer cause installation of the software update on the network printer.

### CROSS-REFERENCE TO RELATED APPLICATIONS

This is a continuation-in-part of U.S. patent application Ser. No. 10/156,303 filed on May 28, 2002 entitled, “SYSTEM UPDATE PROTOCOL”, the entirety of which is incorporated herein.

### BACKGROUND OF THE INVENTION

This invention is related to a communication protocol for updating files on a printer controller.

A printer controller (or printer), which function is to control all printing functions on a related peripheral output device, will sometimes require files to be loaded from external distribution means for the purpose of providing software upgrades, new software installations, and/or batch configurations. Some printers allow these tasks to be done by physically copying the files to the printer controller via a storage distribution device (e.g., CD-ROM, floppy drive, etc.), and then executing corresponding commands for setup and configuration through conventional input devices (e.g., mouse and keyboard) and a video display panel.

This process proves to be impractical and time-consuming when an administrator has to manage many such printers that are remotely located at many different sites (or network nodes) such as buildings or even across the country.

A workstation user may easily apply a patch for a certain component by running the self-extracting and self-installing patch file provided by a vendor. The same patch may also be applied to the printer controller with the same components. However, because the printer lacks input device accommodations (e.g., monitor, keyboard), it is not easy to initiate the install process of such software updates.

What is needed is a client-server networking protocol that would facilitate uploading of the required file(s) to the printer controller, and issuing of any commands necessary for installation.

### SUMMARY OF THE INVENTION

The present invention disclosed and claimed herein, in one aspect thereof, comprises a system update protocol. A software update is packed into a packed file, which packed file includes a unique signature. The packed file is uploaded from a trusted client computer to the network printer. The integrity of the packed file is automatically checked on the network printer by performing a checksum and signature comparison to ensure the packed file is transmitted correctly. The packed file is resent from the client when the packed file is determined to be corrupt. The packed file is unpacked into a predetermined directory structure of unpacked files. The client computer then signals the network printer cause installation of the software update on the network printer.

Further, in accordance with the present invention, there is provided a method of updating executable software from a selected workstation to an intelligent peripheral device server, in communication with one another via a network. An update of executable software contained in a packed file is transmitted from the workstation to the intelligent peripheral device server. The packed file is associated with data containing a unique signature and checksum that is recognizable by the intelligent peripheral device server. The intelligent peripheral device server then receives the software update data. An authentication signal is then generated according to a test of the packed file integrity to determine whether the file was transmitted properly. The packed file is then unpacked according to the authentication signal and installed on the intelligent peripheral device server. The software associated with the software update is subsequently executed on the intelligent peripheral device server.

In a preferred embodiment, the method also includes transmitting data containing a software update in a packed file to a second intelligent peripheral device server. The packed file is associated with a unique signature and checksum, which are recognizable by the second intelligent peripheral device server. An authentication signal is then generated according to a test of the packed file. The packed file is unpacked according to the generated authentication signal. The software update is then installed and executed on the second intelligent peripheral device server.

Still further, in accordance with the present invention, there is provided a system of updating executable software from a selected workstation to an intelligent peripheral device server. The system includes transmitting means adapted to transmit data from the workstation to the intelligent peripheral device. The data suitably includes an update of executable software, which is contained in a packed file. The packed file is associated with a unique signature and checksum that is recognizable by the intelligent peripheral device server. The system also includes receiving means adapted to receive the software update data and generating means adapted to generate an authentication signal according to a test of the packed file integrity to determine whether or not the data was properly transmitted. The system employs unpacking means suitably adapted to unpack the packed file according to the authentication signal and installation means adapted to install the software update on the intelligent peripheral device server. The system further includes execution means adapted to execute the software associated with the software update on the intelligent peripheral device server.

In a preferred embodiment, the system also includes transmission means adapted to transmit data representing a software update to a second intelligent peripheral device server. The software update data is in the form of a packed file associated with a unique signature and checksum that are recognizable by the second intelligent peripheral device server. The system further includes generating means adapted to generate an authentication signal according to a test of the packed file integrity to determine whether the data was transmitted properly. In this embodiment, the system also comprises unpacking means adapted to unpack the packed file according to the authentication signal and installation means adapted to install the software update on the second intelligent peripheral device server.

### BRIEF DESCRIPTION OF THE DRAWINGS

For a more complete understanding of the present invention and the advantages thereof, reference is now made to the following description taken in conjunction with the accompanying drawings, in which:

FIG. 1 illustrates a client/server protocol exchange flow diagram of the protocol; and

FIG. 2 illustrates a client/server system block diagram utilizing the disclosed protocol architecture.

### DETAILED DESCRIPTION OF THE INVENTION

The disclosed protocol architecture provides the capability of allowing the print controller to execute the installation commands after correctly receiving the file.

Unlike most popular file transfer protocols, the disclosed system update protocol is not limited to a single underlying transport. It is designed to run on, for example, TCP/IP (Transmission Control Protocol/Internet Protocol—a Microsoft® protocol suite) and IPX/SPX (Internet Packet eXchange/Sequenced Packet eXchange—a Novell® communication protocol). Thus a client user may choose either transport protocol allowing the server program running on the print controller the capability of responding.

The protocol consists of a reduced set of commands. The one or more target files are packed (i.e., compressed into a single large file) into a packed file, and a signature is prepended to the packed file for security reasons. The packed file may be optionally encrypted with a special agreed-upon key for added security.

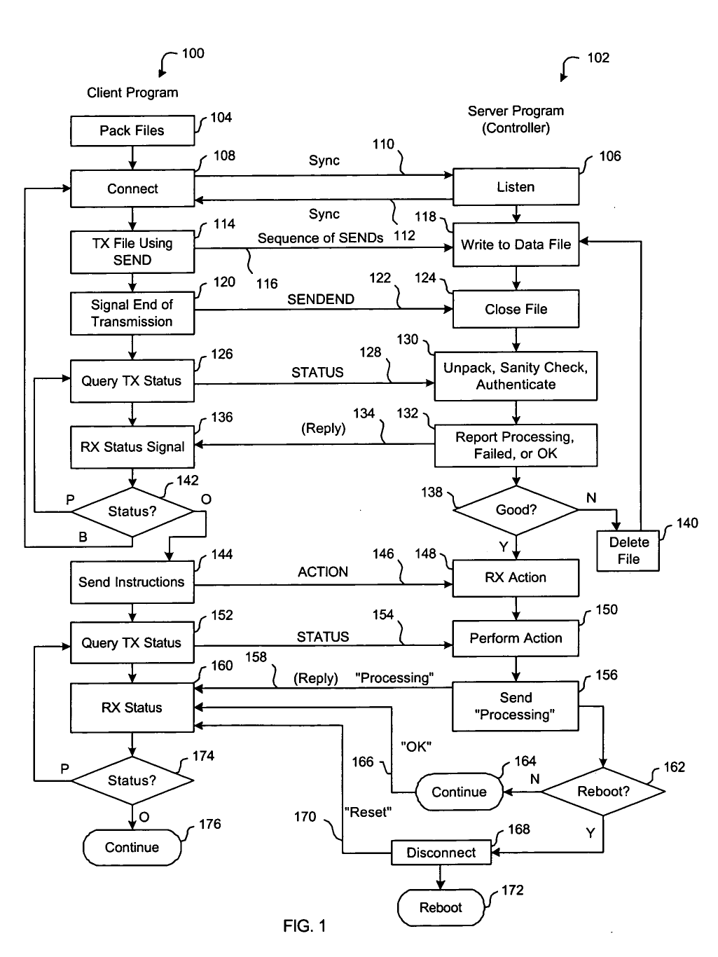

Referring now to FIG. 1, there is illustrated a client/server protocol exchange flow diagram of the protocol. The horizontal lines between a client program flow diagram 100 and server program flow diagram 102 denote the direction and type of content of the network packets exchanged between the client program on a client and server program on the print controller (also denoted as a peripheral output device), while the vertical lines between the blocks of a flow diagram denote the flow of control.

The disclosed protocol consists of the following commands: SEND, to transfer a chunk of the target file; SENDEND, to signal the end of transferring; ACTION, to instruct the server what to do with the file; STATUS, to check the status of the action; and STATUSREPLY, to return the status of the transfer or action.

The server program 102 running on the printer controller is responsible for servicing these commands. The client program 100 running on a workstation (or client) is the driver of a task, i.e., the client controls the processes on the printer controller. Flow begins in a function block 104 where the client program 100 first “packs” all of the appropriate files into a single packed file, which single packed file includes a file header that contains a special signature recognized only by the printer controller (i.e., server program) and trusted client programs. The signature may be encrypted by a variable key (e.g., based upon file size) so that it cannot simply be copied to another file header. The client program 100 also appends a checksum to the end of the packed file. Thus the integrity of the packed file can be ascertained by checking both the unique signature and the checksum.

The server program 102 is currently in a “listen” mode, as indicated in a function block 106, awaiting incoming commands from a client. Flow is then to a function block 108 where the client program 100 performs a connect function by initiating a synchronization (i.e., also denoted as “synch”) operation over a flow line 110 to the function block 106 of the server program 102 in order to establish a reliable connection to the printer controller. The server program 102 responds with synch commands over a flow line 112 to the function block 108. On the server side, two listening sockets will be opened; one for TCP/IP traffic, and another for IPX/SPX traffic.

Flow in the client program 100 is then to a function block 114 where the packed file is transmitted to the printer controller through a sequence of SEND commands. The client program 100 then issues the sequence of SEND commands to the server program 102, as indicated by a signal flow line 116 to a function block 118, to transfer the packed file to the printer controller. Flow in the server program 102 is to the function block 118 where the SEND commands are received, and the received file segments associated with the sequence of the SEND commands are written as a single data file set.

In an alternate embodiment, the server side is suitably equipped with two sockets accepting TCP/IP traffic, IPX/SPX traffic, and the like. The server program 102, while in “listen” mode, indicated at function block 106, waits for incoming commands from the client over the communications channel corresponding to the first socket. Flow then continues to function block 108, wherein the client program 100 performs a synch operation over the flow line 110 to the function block 106 of the server program in order to establish a reliable connection to the controller. As mentioned above, the server program 102 responds with synch commands over the flow line 112 to the function block 108. In the alternate embodiment, the synch command from the client side suitably includes an update request for the controller, i.e., a request to the controller to prepare to receive one or more updates.

Once an update request has been received by the server program 102, the server side connects with the client program 100 on the client side via a second socket. As will be understood by those skilled in the art, the second socket functions as a data channel, enabling transmission of the packed file to the server side. The skilled artisan will also appreciate that the use of the second socket for data transmission enables the first socket to be used as a control channel, allowing the channel to remain open for receipt of control commands, e.g., ABORT and the like, and status updates, e.g., transfer complete, correctness, authenticity, and the like.

Following activation of the second, data transmission socket, flow in the client program 100 is then to a function block 114 where the packed file is transmitted to the printer controller through a sequence of SEND commands. The client program 100 then issues the sequence of SEND commands to the server program 102, as indicated by a signal flow line 116 to a function block 118, to transfer the packed file to the printer controller over the data channel. Flow in the server program 102 is to the function block 118 where the SEND commands are received, and the received file segments associated with the sequence of the SEND commands are written as a single data file set. In an alternate embodiment, the packed file is transmitted to the server program 102 via the second data channel while the SEND commands are transmitted to the server program 102 via the first command channel. In both embodiments, the received file segments and the associated SEND commands sequence are written as a single data file. As will be appreciated by those skilled in the art, additional system upgrade status is capable of being obtained via SNMP traffic.

Once the end of the file transfer from the client program 100 is reached, flow in the client program 100 is to a function block 120 where the client program 100 transmits a SENDEND command to the server program 102, as indicated by a signal flow line 122 to a function block 124. Flow in the server program 102 is to the function block 124 where after the last file segment has been received, and the server program 102 closes the data file. When the server program 102 receives SENDEND command, it will have received the entire file.

Flow in the client program 100 is then to a function block 126 where the client program 100 queries the server program 102 for the status of the file transmission by sending the STATUS command, as indicated by a signal flow line 128 to a function block 130. Flow in the server program 102 is to the function block 130 where the data file is unpacked, and a “sanity” check is performed to determine if the file was correctly transmitted, i.e., by authenticating the signature, recalculating the checksum, etc.

While the sanity check is being performed, flow in the server program 102 is to a function block 132 where the printer controller sends back a “processing” Reply signal to the client program 100, as indicated by a signal flow line 134 to a function block 136. In the server program 102, flow continues to a decision block 138 to determine if the received packed file passed the sanity check. If not, flow is out the “N” path to a function block 140, where the packed file is deleted. Flow then loops back to the input of the function block 118 to receive the next retransmission of the packed file.

The server program 102 also signals the client program 100 in the Reply signal of packed file failing the sanity check (i.e., a “corrupted” file). Flow in the client program 100 is to the function block 136 where the status Reply is received. The client program 100 then interrogates the received status Reply signal, as indicated in a decision block 142. If the Reply signal indicates that the server program 102 is in a state of “processing,” flow is out the “P” path back to the input of the function block 126 to continue querying the server program 102. Alternatively, if the Reply signal indicates a “failed” or “bad” sanity check, flow is out the “B” path of decision block 142 back to the input of function block 114 where the client program 100 resends the packed file to the server program 102 in the sequence of SEND commands.

If the sanity check by the server program 102 is “OK”, the Reply signal to the function block 136 of the client program 100 indicates the same, and flow is out the “O” path of the decision block 142 to a function block 144 where the client program 100 sends an ACTION command to the server program 102 instructing the server program 102 to unpack the file set and reconstruct the directory structure associated therewith. (Of course, to facilitate this directory structuring, the printer controller includes a readable storage medium, e.g., hard disk drive, or a sufficient amount of RAM memory to accommodate the unpacked files.) This is indicated by a signal flow line 146 from the function block 144 of the client program 100 to a function block 148 of the server program 102. The ACTION instructions can further include the actions of “controller software update,” “run,” or “configure.”

Flow in the server program 102 is to the function block 148 where the ACTION signal is received and processed. Flow in the server program 102 is to a function block 150 where the received ACTION is performed. The “controller software update” action initiates a predefined installation process in the printer controller to upgrade the existing software. For software installed utilizing the “run” command, the packed file includes at least one executable file. The “run” action simply causes execution of the one or more executable files of the unpacked file set, which is suitable for installing patches for a single module. The “configure” action initiates a special operating system process, e.g., a system command associated with RegEdit, to add/change some system parameters of the printer controller, as specified in the unpacked file set.

The client program 100 may optionally check the execution status of the ACTION in the server program 102. Thus flow is to a function block 152 of the client program 100 where a STATUS signal is transmitted to the server program 102, as indicated by a signal flow line 154 from the function block 152 to the function block 150. If the server program 102 is in the state of executing the ACTION instruction, flow is to a function block 156 where the server program 102 transmits a “processing” Reply signal to the client program 100, as indicated by a Reply signal flow line 158 to a status function block 160 of the client program 100. Note that where the print controller is undergoing an update, the processing time may take longer.

After completion of the ACTION instruction, the server program 102 may need to be rebooted. Thus flow is to a decision block 162 to determine if the server program 102 needs to be rebooted, in accordance with the particular ACTION instruction. If not, flow is out the “N” path of decision block 162 to a Continue terminal 164 of the server, and therefrom signaling an “OK” status across a signal line 166 to the status function block 160 of the client program 100 to indicate that the ACTION has been completed without a reboot. When a reboot is required, flow is out the “Y” path of decision block 162 of the server program 102 to a function block 168 to terminate the connection to the client program 100 during the rebooting process. A “Reset” signal is then transmitted from the server program 102 to the status function block 160 of the client program 100, as indicated by a signal flow line 170 to the status function block 160. Flow is then to a reboot terminal 172 where the server program is rebooted to implement the software updates. Note that the connection between the client and server will not automatically restore after the printer controller restarts.

The client program 100 then takes the appropriate action in response to the signals received into the status function block 160. Thus flow is to a decision block 174 where the client program 100 interrogates the status signals received from the server program 102. If the status is “processing,” flow is out the “P” path back to the input of the function block 152 to continue querying the server program 102. If the status is either “OK” or “Reset,” flow is out the “O” path to a Continue terminal 176 of the client.

The details of Continue terminal 176 of the client are not shown in FIG. 1. The client program 100 may choose to start another transfer on the same connection, i.e., the process associated with a new sequence of SEND commands in the function block 114, or disconnect from the server program 102 (printer controller) and start a new connection to another printer controller.

The details of the Continue terminal 164 on the server side are not shown in FIG. 1. The server program 102 (printer controller) will delete the received file and go back to wait for a new sequence of SEND commands, as associated with function block 118. If the connection is terminated by the client, the controller will return to the listening mode associated with function block 102, to wait for a new connection.

The disclosed protocol works well for a special-purpose printer controller running on top of the operating system having networking support. A general-purpose file transfer protocol (e.g., FTP (File Transfer Protocol)) does not fit the need of issuing specialized commands. The Berkeley socket interface can be used to implement both the client program 100 and server program 102.

Except for the STATUS command, all the other commands do not require an explicit acknowledgment-type of reply from the server. The underlying transport will ensure the correct delivery of the data.

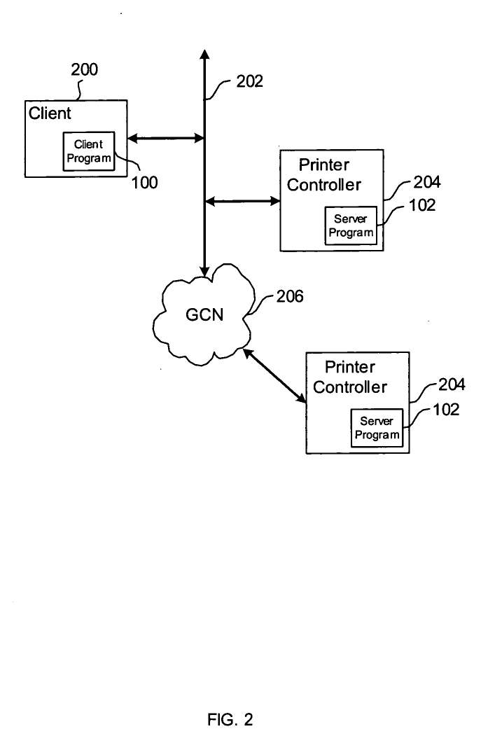

Referring now to FIG. 2, there is illustrated a block diagram of client/server system utilizing the disclosed protocol architecture. A client computer 200 is disposed on a network 202, e.g., a LAN, WAN, etc., in communication with a first network peripheral output device 204, which in this particular embodiment is a printer controller. Note that the first network peripheral output device 204 is not restricted to a printer controller, but can be a variety of network-based equipment suitably configured to execute the disclosed protocol architecture, for example, a multi-function output device (that includes capabilities of faxing, scanning, printing, etc.). The client computer 200 includes the client protocol program 100, and the first peripheral output device 204 includes the server program 102. Both of the client and server protocol programs (100 and 102) can be implemented in firmware (e.g., EEPROM) in either or both of the client computer 200 and the first peripheral output device 204.

As indicated hereinabove, the first peripheral output device 204 opens two listening sockets to accommodate either or both TCP/IP traffic and IPX/SPX traffic communicated across the network 202. Thus if the client computer 200 sends only IPX/SPX traffic on the relatively local network 202, the first peripheral output device 204 can communicate with the client computer 200 to receive the updated software, and execute the disclosed protocol to facilitate the installation of the software and ascertain the status of the updating process on the first peripheral output device 204. In accordance with the alternate embodiment, discussed above, the first peripheral output device 204 opens a first socket to accommodate command traffic and a second socket to accommodate data traffic. In such an embodiment, the traffic is suitably TCP/IP, IPX/SPX, a combination thereof, and the like.

It is appreciated that networks can extend great distances utilizing a global communication network (GCN) 206, e.g., the Internet, over which communication is facilitated utilizing the TCP/IP protocol suite. Thus a second peripheral output device 208 disposed on the GCN 206 and executing the disclosed server protocol 102 will also open the two listening sockets to accommodate either or both TCP/IP traffic and IPX/SPX traffic communicated across the GCN 206. Thus the client computer 200 can be used to upload software to the second peripheral output device 208, and monitor the software installation process.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A method of updating executable software from a selected workstation to an intelligent peripheral device server, in communication with one another via a network, comprising the steps of:
transmitting, from the selected workstation to the intelligent peripheral device server, data representative of an update of executable software contained in at least one packed file to the intelligent peripheral device server, wherein the at least one packed file is associated with data representative of at least one of a unique signature and checksum transmitted therewith that is recognizable by the intelligent peripheral device server;
receiving the data representative of a software update into the intelligent peripheral device server,
generating an authentication signal in accordance with a test of packed file integrity to determine whether it was transmitted properly;
unpacking the at least one packed file in accordance with the authentication signal;
installing the software update on the intelligent peripheral device server; and
executing software associated with the software update on the intelligent peripheral device server.

2. The method according to claim 1 wherein the data representative of at least one of a unique signature and checksum is prepended to the at least one packed file.

3. The method according to claim 1 wherein the at least one packed file is unpacked into a selected directory structure.

4. The method according to claim 1 further comprising the step of opening a communication channel for transmitting the at least one packed file to the intelligent peripheral device server.

5. The method according to claim 1 further comprising the step of transmitting programming data to the intelligent peripheral device\server, wherein such programming data instructs the intelligent peripheral server device to selected operations.

6. The method according to claim 1 further comprising the steps of:
transmitting data representative of a query to the intelligent peripheral device server as to outcome of packed file integrity; and
generating reply data in response the query; and
transmitting the reply data from the intelligent peripheral device server.

7. The method according to claim 1 further comprising the step of, in the event the packed file integrity is not authenticated, deleting the software update data from the intelligent peripheral device server.

8. The method according to claim 7 further comprising the steps of:
generating a failure signal in the event that the packed file integrity was not authenticated; and
transmitting the failure signal from the intelligent peripheral device server.

9. The method according to claim 8 further comprising the step of in response to receiving the failure signal, retransmitting the software update data to the intelligent peripheral device server.

10. The method according to claim 1 further comprising the steps of:
detecting a status condition associated with the software update on the intelligent peripheral device server;
generating data representative of the status condition; and
transmitting the status condition data from the intelligent peripheral device server.

11. The method according to claim 1 further comprising the steps of:
transmitting data representative of a software update in the form of at least one packed file to at least a second intelligent peripheral device server, wherein the at least one packed file is associated with data representative of at least one of a unique signature and checksum transmitted therewith that is recognizable by the second intelligent peripheral device server;
generating an authentication signal in accordance with a test of packed file integrity to determine whether it was transmitted properly;
unpacking the at least one packed file in accordance with the authentication signal;
installing the software update on the second intelligent peripheral device server; and
executing software associated with the software update on the intelligent peripheral device server.

12. A system of updating executable software from a selected workstation to an intelligent peripheral device server, via communication with a network comprising:
means adapted for transmitting data from the selected workstation to the intelligent peripheral device server, which data is representative of an update of executable software contained in at least one packed file to the intelligent peripheral device server, wherein the at least one packed file is associated with data representative of at least one of a unique signature and checksum transmitted therewith that is recognizable by the intelligent peripheral device server;
means adapted for receiving the data representative of a software update into the intelligent peripheral device server;
means adapted for generating an authentication signal in accordance with a test of packed file integrity to determine whether it was transmitted properly;
means adapted for unpacking the at least one packed file in accordance with the authentication signal;
means adapted for installing the software update on the intelligent peripheral device server; and
means adapted for commencing execution of software associated with the software update on the intelligent peripheral device server.

13. The system according to claim 12 wherein the data representative of at least one of a unique signature and checksum is prepended to the at least one packed file.

14. The system according to claim 12 wherein the at least one packed file is unpacked into a selected directory structure.

15. The system according to claim 12 further comprising means adapted for opening a communication channel for transmitting the at least one packed file to the intelligent peripheral device server.

16. The system according to claim 12 further comprising means adapted for transmitting programming data to the intelligent peripheral device server, wherein such programming data instructs the intelligent peripheral device server to selected operations.

17. The system according to claim 12 further comprising:
means adapted for transmitting data representative of a query to the intelligent peripheral device server as to outcome of packed file integrity; and
means adapted for generating reply data in response the query; and
means adapted for transmitting the reply data from the intelligent peripheral device server.

18. The system according to 12 further comprising means adapted for, in the event the packed file integrity is not authenticated, deleting the software update data from the intelligent peripheral device server.

19. The system according to claim 18 further comprising:
means adapted for generating a failure signal in the event that the packed file integrity was not authenticated; and
means adapted for transmitting the failure signal from the intelligent peripheral device server.

20. The system according to claim 19 further comprising means adapted for, in response to receiving the failure signal, retransmitting the software update data to the intelligent peripheral device server.

21. The system according to claim 20 further comprising:
means adapted for detecting a status condition associated with the software update on the intelligent peripheral device server;
means adapted for generating data representative of the status condition; and
means adapted for transmitting the status condition data from the intelligent peripheral device server.

22. The system according to claim 12 further comprising:
means adapted for transmitting data representative of a software update in the form of at least one packed file to at least a second intelligent peripheral device server, wherein the at least one packed file is associated with data representative of at least one of a unique signature and checksum transmitted therewith that is recognizable by the second intelligent peripheral device server;
means adapted for generating an authentication signal in accordance with a test of packed file integrity to determine whether it was transmitted properly;
means adapted for unpacking the at least one packed file in accordance with the authentication signal; and
means adapted for installing the software update on the second intelligent peripheral device server.

23. A computer-implemented method of updating executable software from a selected workstation to an intelligent peripheral output device server via a network comprising the steps of:
transmitting data representative an update of executable software contained in at least one packed file from a selected workstation to the intelligent peripheral device server, wherein the at least one packed file is associated with data representative of at least one of a unique signature and checksum transmitted therewith that is recognizable by the intelligent peripheral device server;
receiving the data representative of a software update into the intelligent peripheral device server;
generating an authentication signal in accordance with a test of packed file integrity to determine whether it was transmitted properly;
unpacking the at least one packed file in accordance with the authentication signal;
installing the software update on the intelligent peripheral device server; and
initiating execution of executable software associated with the software update on the intelligent peripheral device server.

24. The computer-implemented method according to claim 23 further comprising the steps of:
transmitting data representative of a query to the intelligent peripheral device server as to outcome of packed file integrity; and
generating reply data in response the query; and
transmitting the reply data from the intelligent peripheral output device server.

25. The computer-implemented method according to claim 23 further comprising the steps of:
in the event the packed file integrity is not authenticated, deleting the software update data from the intelligent peripheral device server;
generating a failure signal in the event that the packed file integrity was not authenticated;
transmitting the failure signal from the intelligent peripheral output device server, and
in response to receiving the failure signal, retransmitting the software update data to the intelligent peripheral device server.

26. The computer-implemented method according to claim 23 further comprising the steps of:
detecting a status condition associated with the software update on the intelligent peripheral device server;
generating data representative of the status condition; and
transmitting the status condition data from the intelligent peripheral device server.

27. A computer-readable medium of updating software from a selected workstation to an intelligent peripheral device server via a network comprising:
means adapted for transmitting data representative of an update of executable software update contained in the form of at least one packed file from the selected workstation to the intelligent peripheral device server, wherein the at least one packed file is associated with data representative of at least one of a unique signature and checksum transmitted therewith that is recognizable by the intelligent peripheral device server;
means adapted for generating an authentication signal in accordance with a test of packed file integrity to determine whether it was transmitted properly;
means adapted for unpacking the at least one packed file in accordance with the authentication signal;
means adapted for installing the software update on the intelligent peripheral device server; and
means adapted for initiating execution of executable software associated with the software update on the intelligent peripheral device server.

28. The computer-readable medium according to claim 27 further comprising:
means adapted for transmitting data representative of a query to the intelligent peripheral device server as to outcome of packed file integrity; and
means adapted for generating reply data in response the query; and
means adapted for transmitting the reply data from the intelligent peripheral device server.

29. The computer-readable medium according to claim 27 further comprising:
means adapted for, in the event the packed file integrity is not authenticated, deleting the software update data from the intelligent peripheral device server;
means adapted for generating a failure signal in the event that the packed file integrity was not authenticated;
means adapted for transmitting the failure signal from the intelligent peripheral device server; and
means adapted for, in response to receiving the failure signal, retransmitting the software update data to the intelligent peripheral device server.

30. The computer-readable medium according to claim 27 further comprising:
means adapted for detecting a status condition associated with the software update on the intelligent peripheral device server;
means adapted for generating data representative of the status condition; and
means adapted for transmitting the status condition data from the intelligent peripheral device server.
